(19) United States
(12) Patent Application Publication
(10) Pub. No.: US 2026/0145335 A1
(43) Pub. Date: May 28, 2026

(54) COLLABORATIVE ROBOT SYSTEM

(71) Applicant: AISAN KOGYO KABUSHIKI KAISHA, Obu-shi (JP)

(72) Inventors: Taisuke KAGAU, Kariya-shi (JP); Ryosuke MIYACHI, Komaki-shi (JP); Shinji KAWAI, Gifu-shi (JP); Masahi OZEKI, Obu-shi (JP); Yoshihiro SAKUMA, Kariya-shi (JP); Yuma KAKO, Nagoya-shi (JP); Shoichiro SATO, Mizuho-shi (JP)

(21) Appl. No.: 19/396,645

(22) Filed: Nov. 21, 2025

(30) Foreign Application Priority Data
Nov. 25, 2024 (JP) 2024-204913

(51) Int. Cl. B25J 9/16

(52) U.S. Cl. CPC B25J 9/1694; B25J 9/1664

(57) ABSTRACT

A collaborative robot system may include a collaborative robot including a working robot, wherein the collaborative robot is mounted on a movable platform and movable with a user to predetermined locations. An irradiation unit configured to emit an infrared ray in a predetermined direction may be located at each of the predetermined locations. The collaborative robot may further include a control unit configured to control an operation of the working robot, a light receiving unit configured to receive the infrared ray, and a notification unit configured to notify a state of the movable platform.

### CROSS REFERENCE TO RELATED APPLICATION

This application claims priority to Japanese Patent Application No. 2024-204913 filed on Nov. 25, 2024. The entire content of the priority application is incorporated herein by reference.

### TECHNICAL FIELD

The disclosure herein relates to a collaborative robot system.

### BACKGROUND ART

Japanese Patent Application Publication No. 2006-048631 describes a robot system including a movable robot configured to move toward a user in response to a summoning command. When the movable robot of the robot system of Japanese Patent Application Publication No. 2006-048631 receives an infrared ray emitted from a summoning device carried by the user, it calculates the direction of the summoning device and changes its orientation to move in the summoned direction.

In the field of robots, collaborative robots configured to work with a user are known. These collaborative robots require the user to move the robots to predetermined locations. If the positioning accuracy of the collaborative robot relative to the predetermined location is low, the collaborative robot may not be able to work properly. However, it is complicated and time-consuming for the user to accurately position the collaborative robot relative to the predetermined location. In view of this, there is a need for technology that enables high-accuracy positioning of a collaborative robot relative to predetermined locations. The disclosure herein aims to provide such a technology that enables high-accuracy positioning of a collaborative robot relative to predetermined locations.

### SUMMARY

According to a first aspect of the technology disclosed herein, a collaborative robot system may comprise a collaborative robot comprising a working robot. The collaborative robot may be mounted on a movable platform and movable with a user to predetermined locations. An irradiation unit configured to emit an infrared ray in a predetermined direction may be located at each of the predetermined locations. The collaborative robot may further comprise a control unit configured to control an operation of the working robot, a light receiving unit configured to receive the infrared ray, and a notification unit configured to notify a state of the movable platform.

### BRIEF DESCRIPTION OF DRAWINGS

FIG. 1 illustrates a schematic diagram of a collaborative robot.

FIG. 2 illustrates a schematic diagram of a collaborative robot system.

### DETAILED DESCRIPTION

According to a first aspect of the technology disclosed herein, a collaborative robot system may comprise a collaborative robot comprising a working robot. The collaborative robot may be mounted on a movable platform and movable with a user to predetermined locations. An irradiation unit configured to emit an infrared ray in a predetermined direction may be located at each of the predetermined locations. The collaborative robot may further comprise a control unit configured to control an operation of the working robot, a light receiving unit configured to receive the infrared ray, and a notification unit configured to notify a state of the movable platform.

According to the first aspect, since the notification unit notifies the state of the movable platform while the user is moving the collaborative robot to a predetermined location, the user can recognize that the collaborative robot (the movable platform) has arrived at the predetermined location. This allows for high-accuracy positioning of the collaborative robot relative to the predetermined location. Further, when receiving an infrared ray, the notification unit notifies this reception of infrared ray, and thus the user can easily recognize a desired collaborative robot.

In a second aspect of the technology disclosed herein according to the first aspect, the predetermined locations may be assigned with different identification numbers, and the collaborative robot may move based on the identification numbers.

According to the second aspect, the collaborative robot can be properly positioned relative to each of the predetermined locations. For example, the distance between a first predetermined location and the collaborative robot when used at the first predetermined location can be differentiated from the distance between a second predetermined location and the collaborative robot when used at the second predetermined location.

In a third aspect of the technology disclosed herein according to the first or second aspect, the control unit may stop the operation of the working robot when the light receiving unit does not receive the infrared ray.

According to the third aspect, it can be determined that the collaborative robot is not positioned at a predetermined location, and in such a case, the operation of the working robot is stopped. This improves the safety of work performed using the collaborative robot.

In a fourth aspect of the technology disclosed herein according to any one of the first to third aspects, the collaborative robot system may further comprise a solar cell, and the solar cell may supply power to at least one of the light receiving unit and the control unit.

According to the fourth aspect, power consumption from the grid can be reduced.

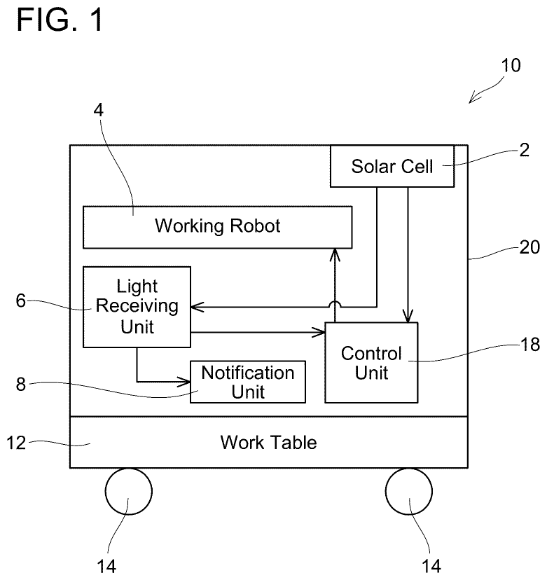

Referring to FIG. 1, a collaborative robot 20 is described. The collaborative robot 20 constitutes a part of a collaborative robot system 10. The entire collaborative robot system 10 will be described later. The collaborative robot 20 moves with a user to, for example, manufacturing locations (predetermined locations) within a factory and the like, and can be used to move and/or inspect workpieces.

The collaborative robot 20 is mounted on a movable platform 12. The movable platform 12 includes canisters 14. By transferring the movable platform 12, the collaborative robot 20 can be transferred to predetermined locations. The collaborative robot 20 comprises a control unit 18, a working robot 4, a light receiving unit 6, a notification unit 8, and a solar cell 2.

The control unit 18 controls operation of the working robot 4. The control unit 18 prohibits the working robot 4 to operate when the collaborative robot 20 is not positioned at a predetermined position, and permits the working robot 4 to operate when the collaborative robot 20 is positioned at a predetermined location. The working robot 4 performs a predetermined operation in accordance with a program stored in the control unit 18 or user's instructions. For example, the working robot 4 can move a workpiece or assemble a component to a workpiece at each predetermined location.

The light receiving unit 6 receives infrared rays emitted from irradiation units 30a, 30b, which will be described later. The distance between the collaborative robot 20 and a predetermined location is measured by the light receiving unit 6, so that a positional relationship between the collaborative robot 20 and the predetermined location can be identified. Upon arrival of the collaborative robot 20 at a predetermined location, the light receiving unit 6 transmits a signal to the notification unit 8 and the notification unit 8 notifies the arrival at the predetermined location. The notification unit 8 may provide the notification, for example, in the form of monitor display, buzzer sound, light, or the like. Further, upon arrival of the collaborative robot 20 at a predetermined location, the light receiving unit 6 transmits a signal to the control unit 18 and the control unit 18 permits the working robot 4 to operate.

The solar cell 2 is arranged in an upper portion of the collaborative robot 20. The solar cell 2 supplies power to the light receiving unit 6 and the control unit 18. That is, the light receiving unit 6 and the control unit 18 operate using or supplementally using the power generated by the solar cell 2. The working robot 4 and the notification unit 8 operate using power in a battery (not illustrated) mounted on the collaborative robot 20. The battery may supply power to the light receiving unit 6 and the control unit 18 if necessary.

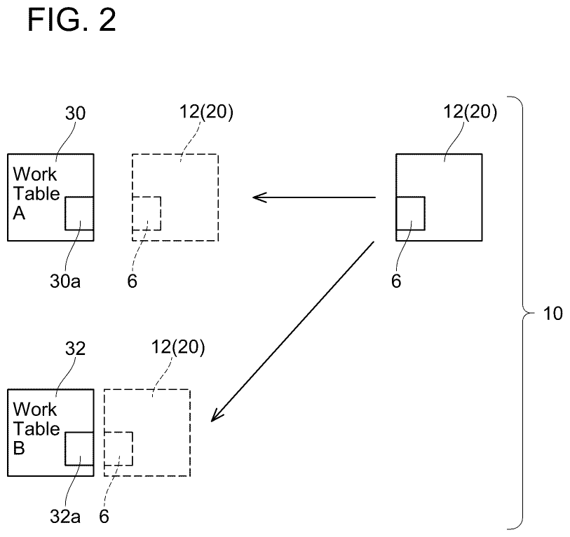

Referring to FIG. 2, the collaborative robot system 10 is described. The collaborative robot 20 may move to a predetermined location 30 (a work table A) and work there and may move to a predetermined location 32 (a work table B) and work there. An irradiation unit 30a is located at the predetermined location 30, and an irradiation unit 32a is located at the predetermined location 32. Each of the irradiation units 30a, 32a can emit an infrared ray toward the collaborative robot 20. The predetermined locations 30, 32 are assigned with different identification numbers, and the irradiation units 30a, 32a emit infrared rays corresponding to the identification numbers.

When the light receiving unit 6 of the collaborative robot 20 receives an infrared ray, the notification unit 8 notifies the reception of the infrared ray (also see FIG. 1). Thus, the user can recognize the location of the collaborative robot 20. The notification unit 8 further notifies from which predetermined location, the predetermined location 30 or 32, the infrared ray was received. Thus, the user can recognize to which predetermined location 30 or 32 he/she should move the collaborative robot 20.

Once the collaborative robot 20 is positioned properly relative to the predetermined location (30 or 32) by the user moving the collaborative robot 20 thereto, the notification unit 8 notifies that the collaborative robot 20 has arrived at the intended position. As described above, different identification numbers are assigned to the predetermined locations 30 and 32. Thus, even when the proper position of the collaborative robot 20 relative to the predetermined location 30 is different from the proper position of the collaborative robot 20 relative to the predetermined location 32, the notification unit 8 can notify that the collaborative robot 20 has arrived at the intended position, considering the proper positions for the predetermined locations 30, 32.

In the collaborative robot system 10, the irradiation units 30a, 32a constantly emit infrared rays to the light receiving unit 6 while the working robot 4 is operating at the predetermined locations 30, 32. The control unit 18 permits the working robot 4 to operate only while the light receiving unit 6 is receiving an infrared ray and stops the operation of the working robot 4 when the light receiving unit 6 does not receive an infrared ray (e.g., when reception of an infrared ray is interrupted).

The collaborative robot system 10 has advantages described hereinafter. In the collaborative robot system 10, the irradiation units 30a, 32a are located at the predetermined locations 30, 32, respectively, and the light receiving unit 6 receives the infrared rays emitted from the irradiation units 30a, 32a. Then, the information received by the light receiving unit 6 is notified via the notification unit 8. Different identification numbers are assigned to the predetermined locations 30, 32. Thus, the distances between the predetermined locations 30, 32 and the collaborative robot 20 can be accurately determined, and the collaborative robot 20 can be properly positioned relative to each of the predetermined locations 30, 32.

The inclusion of the notification unit 8 allows the user to easily find the collaborative robot 20 when the user wishes to use it. Further, the inclusion of the notification unit 8 allows the user to easily recognize to which predetermined location (30 or 32) the collaborative robot 20 is to be moved. Moreover, since the operation of the working robot 4 is stopped when the reception of infrared ray is interrupted, safety can be ensured in the event of an emergency such as displacement of the collaborative robot 20 (the movable platform 12). Additionally, using the power generated by the solar cell 2 allows for a reduction in power consumption from the grid.

### Other Embodiments

The above embodiment has described the collaborative robot system with two predetermined locations, however, the number of predetermined locations is not particularly limited, and it may be one, or three or more. Further, in the embodiment above, different identification numbers are assigned to the predetermined locations, however, in case there are three or more predetermined locations, the same identification number may be assigned to two or more predetermined locations. For example, an identification number X may be assigned to two predetermined locations, an identification number Y may be assigned to one predetermined location, and an identification number Z may be assigned to three predetermined locations. It should be noted that in the collaborative robot system disclosed herein, assigning identification numbers to predetermined locations is not necessary, and predetermined locations may not be assigned with identification numbers.

In the above embodiment, the irradiation units constantly emit infrared rays to the light receiving unit while the working robot is operating, however, the irradiation units may not emit the infrared rays after the collaborative robot has arrived at a predetermined location (i.e., while the working robot is operating).

In the embodiment above, the power generated by the solar cell is supplied to the light receiving unit and the control unit, however, the power generated by the solar cell may be supplied to other unit(s) (e.g., the working robot, the notification unit, etc.). Further, the power generated by the solar cell may be supplied only to the light receiving unit or only to the control unit.

While specific examples of the present disclosure have been described above in detail, these examples are merely illustrative and place no limitation on the scope of the patent claims. The technology described in the patent claims also encompasses various changes and modifications to the specific examples described above. The technical elements explained in the present description or drawings provide technical utility either independently or through various combinations. The present disclosure is not limited to the combinations described at the time the claims are filed. Further, the purpose of the examples illustrated by the present description or drawings is to satisfy multiple objectives simultaneously, and satisfying any one of those objectives gives technical utility to the present disclosure.

What is claimed is

1. A collaborative robot system comprising:
a collaborative robot comprising a working robot, wherein the collaborative robot is mounted on a movable platform and is movable with a user to predetermined locations,
wherein an irradiation unit configured to emit an infrared ray in a predetermined direction is located at each of the predetermined locations, and
wherein the collaborative robot further comprises a control unit configured to control an operation of the working robot, a light receiving unit configured to receive the infrared ray, and a notification unit configured to notify a state of the movable platform.

2. The collaborative robot system according to claim 1,
wherein the predetermined locations are assigned with different identification numbers, and
wherein the collaborative robot moves based on the identification numbers.

3. The collaborative robot system according to claim 1,
wherein the control unit stops the operation of the working robot when the light receiving unit does not receive the infrared ray.

4. The collaborative robot system according to claim 1, further comprising a solar cell,
wherein the solar cell supplies power to at least one of the light receiving unit and the control unit.
